(19) United States
(12) Patent Application Publication
(10) Pub. No.: US 2007/0183836 A1
(43) Pub. Date: Aug. 9, 2007

(54) Wipe applicatior

(76) Inventors: John K. Lampe, Saint Paul, MN (US); Douglas R. Oudekerk, St. Paul, MN (US)

Correspondence Address: John K. Lampe, 262 Griggs Street South, St. Paul, MN, 55105, US

(21) Appl. No.: 11/698,635

(22) Filed: Jan. 26, 2007

Related U.S. Application Data
(60) Provisional application No. 60/764,653, filed on Feb. 3, 2006.
(60) Provisional application No. 60/799,600, filed on May 11, 2006.

(51) Int. Cl. B43K 5/14

(52) U.S. Cl. 401/134; 401/133

(57) ABSTRACT

In a first embodiment, an applicator comprising: a receptacle having walls that form an interior and an exterior, having a projection extending from at least one wall into the interior and toward an opening in the receptacle; a fluid contained in the receptacle; a barrier having a first side and a second side with the first side affixed to the receptacle to seal the opening; and a pad permanently affixed to the second side of the barrier.

In a second, embodiment, a method for releasing fluid from an applicator comprising the steps of: applying force to an exterior surface of a receptacle; forcing a projection extending from the wall of the receptacle into a barrier, which barrier seals an opening in the receptacle; causing a rupture in the barrier with the projection; releasing a fluid through the rupture into a pad permanently affixed to the barrier.

In a third embodiment, an applicator comprising: a sealed film packaging container having an interior side and an exterior side; a pad affixed to the film packaging container on the interior side; and a mount affixed to the film packaging on the exterior side.

This application claims the benefit of United States Provisional Applications No. 60/764,653 filed on Feb. 3, 2006, and No. 60/799,600 filed on May 11, 2006.

### FIELD OF THE INVENTION

The present invention generally relates to a wipe applicator incorporating a reservoir. Wipes can be used for various purposes including applying substances such as fluids to or removing substances such as fluids from a surface.

### BACKGROUND OF THE INVENTION

Wipes can serve many functions. As examples wipes can: apply materials such as coatings (fluids, pastes, and solids) to surfaces; remove coatings such as dirt, dust, or old surface treatments; and modify surfaces such as by abrasion. Finally, wipes can perform combinations of these and other functions.

Wipes can have various features for serving these functions. For example, many wipes are pre-moistened. Pre-moistened wipes can often be used to apply various kinds of coating materials including cleaning solutions, antiseptics, lotions, insect repellants, protective coatings, and so forth.

Other wipes are dispensed dry. Dry wipes may require the user to apply fluid to the wipe or to a target surface. Alternatively, dry wipes may need no fluid because they are used in a wet environment such as a toilet. Finally, some dry wipes may be used dry and, for example, clean by attracting dirt and dust particles with static electricity.

Wipes can be used for various lengths of time. Wipes can generally be considered reusable (typically after a washing or other forms of re-conditioning), reusable for a limited number of times, or disposable.

In addition to wipes, the prior art encompasses various kinds of applicators for wipes. For example, the prior art includes mop-like devices. These devices typically have a long handle and a head for holding wipes for cleaning floors.

The prior art suffers from certain shortcomings or limitations. The purpose of the present invention is to overcome shortcomings or limitations in the prior art.

### SUMMARY OF THE INVENTION

The present invention generally relates to a wipe applicator incorporating a reservoir. Wipes can be used for various purposes such as applying substances such as fluids to or removing substances such as fluids from a surface.

Specifically, the invention relates to a wipe applicator with a reservoir. In at least one embodiment, the reservoir consists of two walls. One wall can have a dome shaped portion. The dome can be inverted which can exert pressure on the second wall causing it to burst. Once the reservoir bursts, fluid can be released into the pad. The user can then employ the wipe without having to touch the impregnated pad.

The above summary of the present invention is not intended to describe each illustrated embodiment, object, advantage, or use of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A is a top perspective view of the wipe applicator with a hand pressing on the dome according to the first embodiment.

FIG. 1B is a top perspective view of the wipe applicator held by a hand according to the first embodiment.

FIG. 1C is an exploded, top perspective view of the wipe applicator according to the first embodiment.

FIG. 1D is a cross sectional, elevation view of the wipe applicator according to the first embodiment.

FIG. 1E is a cross sectional, elevation view of the wipe applicator with the liquid being released according to the first embodiment.

FIG. 1F is a top perspective view of a sheet of the first layer of the reservoir for the wipe applicator according to the first embodiment.

FIG. 2A is a cross sectional, elevation view of the wipe applicator according to the second embodiment.

FIG. 3A is a perspective view of the bottom side of the pouch reservoir according to the third embodiment.

FIG. 3B is a top perspective view of the wipe applicator according to the third embodiment.

FIG. 3C is a top perspective view of the wipe according to the third embodiment.

FIG. 4A is a cross-sectional view of the wipe applicator according to the fourth embodiment.

FIG. 5A is perspective view of the wipe applicator according to the fifth embodiment.

FIG. 5B is a sectional, exploded, elevation view of the components of the wipe applicator according to the fifth embodiment.

FIG. 5C is a sectional, elevation view of the wipe applicator according to the fifth embodiment.

FIG. 5D is a sectional, elevation view of the wipe applicator after downward pressure has burst the wall according to the fifth embodiment.

FIG. 5E is perspective view of a user holding the wipe applicator according to the fifth embodiment.

FIG. 5F is a sectional, elevation view of a variation of the flange of the wipe applicator according to the fifth embodiment.

FIG. 5G is a plan view of the bottom, working surface of the wipe applicator showing bonded portions along the flange according to the fifth embodiment.

FIG. 5H is a plan view of the bottom, working surface of the wipe applicator showing other possible bonded portions according to the fifth embodiment.

FIG. 6A is a sectional, elevation view of the wipe applicator according to the sixth embodiment.

FIG. 6B is a perspective interior view of the formed structure according to a sixth embodiment.

FIG. 7A is a top perspective view of the wipe holder in sealed packaging according to the seventh embodiment.

FIG. 7B is a top perspective view of the wipe holder being unpackaged according to the seventh embodiment.

FIG. 7C is a top perspective view of the wipe holder fully unpackaged according to the seventh embodiment.

FIG. 7D is a top perspective view of the empty packaging for the wipe holder according to the seventh embodiment.

FIG. 7E is a side, exploded view of the wipe holder and packaging according to the seventh embodiment.

FIG. 8A is a top perspective view of the wipe holder fully unpackaged according to the eighth embodiment.

FIG. 8B is a top perspective view of the wipe holder releasably connected to a handle according to the eighth embodiment.

### REFERENCE NUMERALS IN DRAWINGS

100 wipe applicator

101 wipe

102 backing

103 reservoir

104 handle

106 top side of wipe applicator

107 bottom side of wipe applicator

108 working face

109 tear line

110 liquid

111 dome

115 first wall of reservoir

116 second wall of reservoir

117 sheet for first wall

200 wipe applicator

201 wipe

202 backing

203 reservoir

204 handle

206 top side of wipe applicator

207 bottom side of wipe applicator

208 working face

210 liquid

211 dome

215 first wall of reservoir

216 second wall of reservoir

218 pressure point

300 wipe applicator

301 wipe

303 reservoir

304 handle

306 top side of wipe applicator

307 bottom side of wipe applicator

308 working face

315 first wall of reservoir

316 second wall of reservoir

320 first end seam

321 second end seam

322 lengthwise seam

323 strips of adhesive

324 middle of lengthwise seam

325 area between strips

400 wipe applicator

401 wipe

402 backing

403a first reservoir

403b second reservoir

404 handle

406 top side of wipe applicator

407 bottom side of wipe applicator

408 working face

410 liquid

411a first dome

411b second dome

415 first wall of reservoirs

416 second wall of reservoirs

500 wipe applicator

501 wipe

503 reservoir

506 top side of wipe applicator

507 bottom side of wipe applicator

508 working face

510 liquid

515 formed structure

516 wall

518 pressure member

530 flange

531 downward pressure

532 bursting of wall

533 ridge

534 channel

535 ridge cavity

536 vertical portions

537 hand

538 periphery of formed structure

539 bonded areas

540 soaking of liquid into wipe

541 fingers (including thumb)

542 surface being worked on

543 recess in flange

600 wipe applicator

601 wipe

603 reservoir

606 top side of wipe applicator

607 bottom side of wipe applicator

608 working face

610 liquid

615 formed structure

616 wall

618 pressure member

630 flange

631 downward pressure

633 ridge

634 channel

636 vertical portions

703 periphery of formed structure

650 bottom end of pressure member

700 wipe holder

701 wipe

702 backing

703 periphery of backing

704 handle

705 opening in backing for handle

706 top side of wipe holder

707 bottom side of wipe holder

708 working face

709 tear line

710 packaging

711 top wall of packaging

712 bottom wall of packaging

713 sandwiched portion of top wall of packaging

714 adhesive

715 first layer of wipe

716 second layer of wipe

717 openings in top wall of packaging

720 tear in packaging

800 wipe holder

801 wipe

802 backing

803 periphery of backing

804 handle

805 opening in backing for handle mount

813 sandwiched portion of top wall of packaging

825 mount for handle

### DETAILED DESCRIPTION OF THE DRAWING

### Including a Best Mode

As disclosed the invention concerns a wipe applicator with a reservoir. In at least one embodiment, the reservoir consists of two walls. The first wall can have a dome shaped portion. The dome can be inverted which can exert pressure on the reservoir causing the second wall of the reservoir to burst. Once the reservoir bursts, fluid can be released into the wipe. Such a wipe applicator can be used for applying materials to surfaces. However, the invention is not limited to such uses. The structure of the wipe applicator may be useful for other purposes. Other purposes might include, for example, the application of materials to surfaces (such as paints or other coatings), the alteration of surfaces such as with abrasives, or any other use where such a structure might be usable and beneficial. For many uses, the term “pad” may be more suitable than “wipe.” The invention should be understood to encompass these other uses although not discussed below.

### First Embodiment

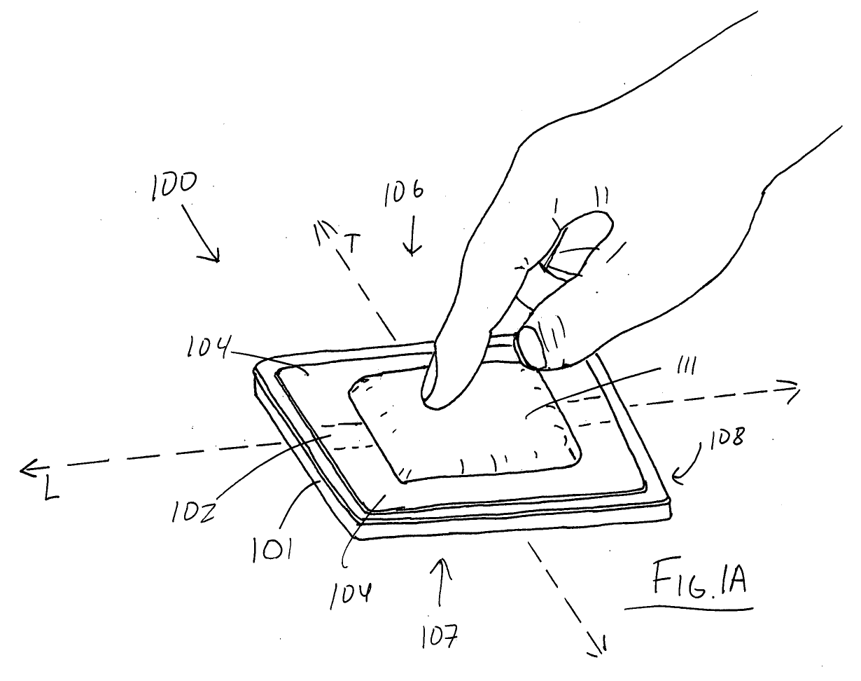

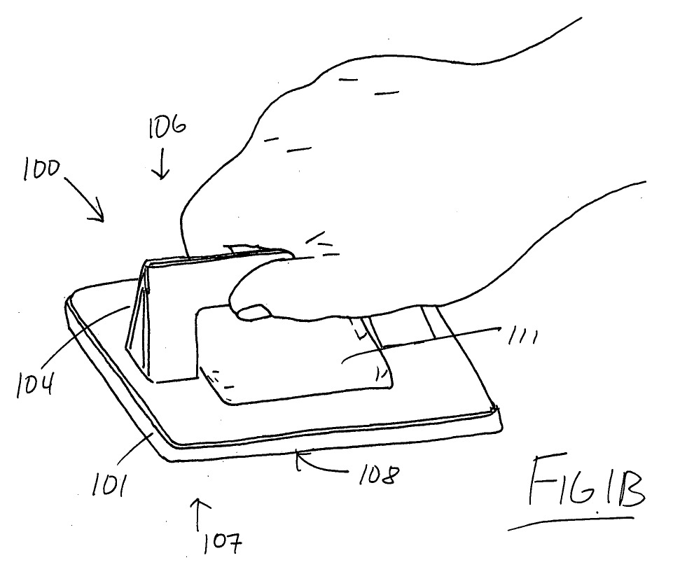

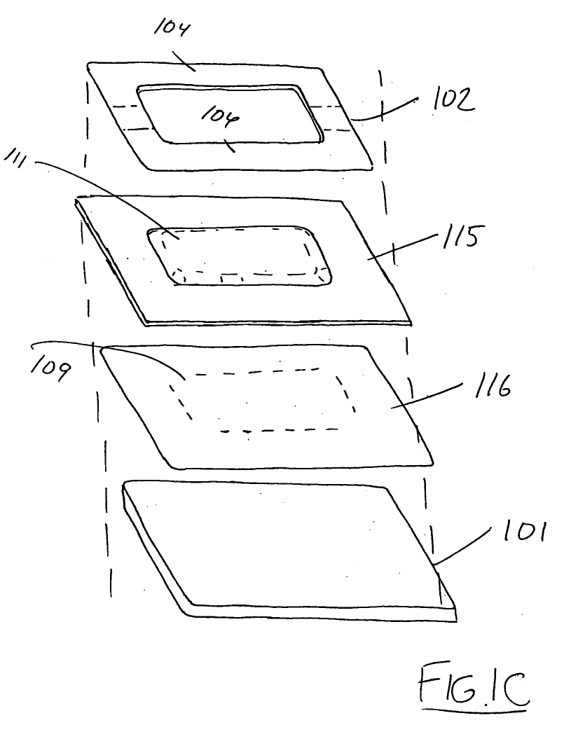

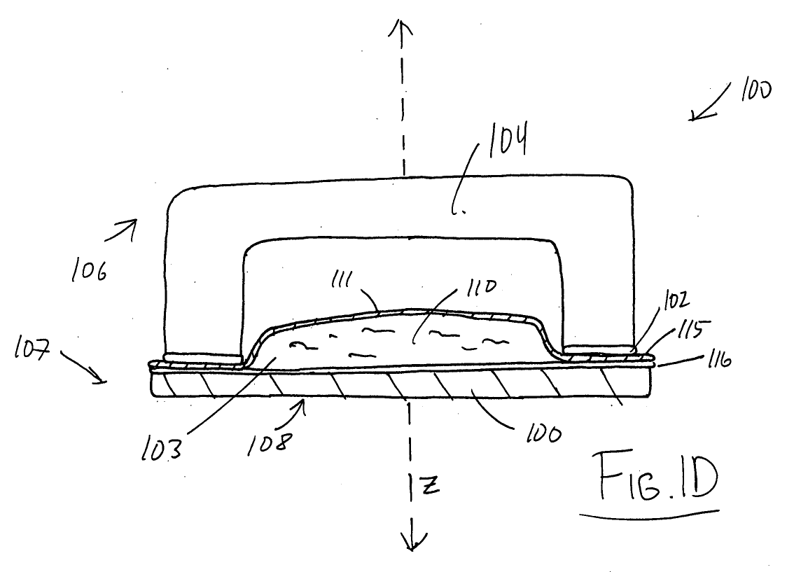

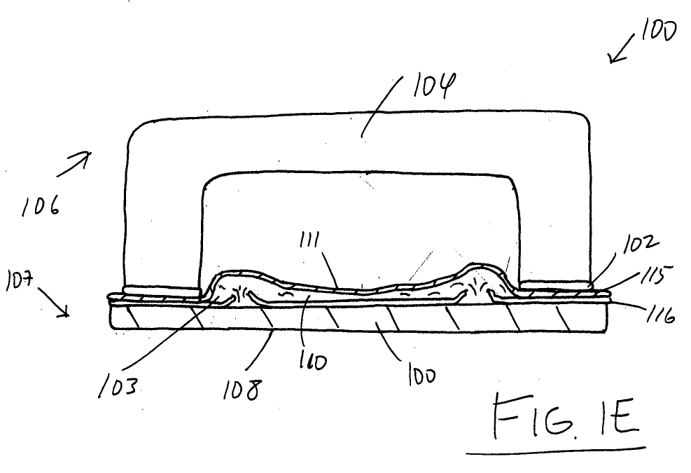

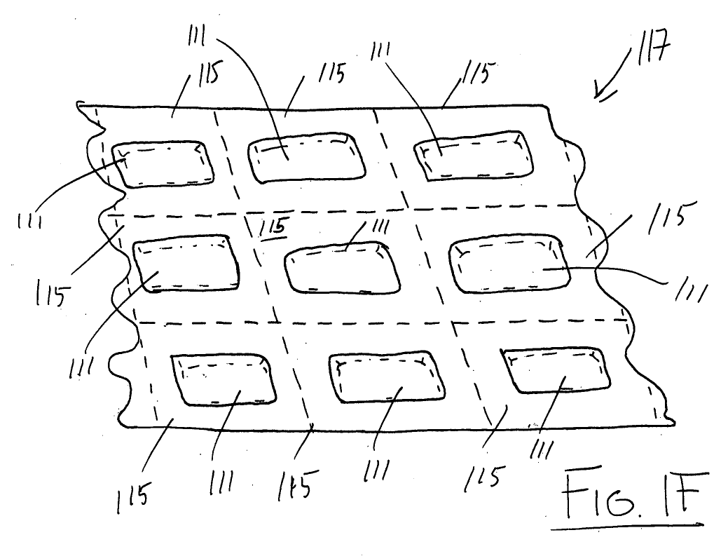

The wipe applicator 100 shown in FIGS. 1A to 1F can be oriented with a longitudinal centerline L generally bisecting the wipe applicator 100. The term “longitudinal” refers to a line, axis, or direction in the plane of the wipe applicator 100 that is aligned with the centerline L. The wipe applicator shown in FIG. 1A can further be oriented with a transverse (or lateral) centerline T that is perpendicular to the longitudinal centerline L. The term “transverse” refers to a line, axis, or direction in the plane of the wipe applicator 100 that is aligned with the centerline T. The wipe applicator 100 can further be oriented with a line z as shown in FIG. 1D, which is perpendicular to the plane formed by centerlines L and T and generally corresponds to the direction associated with the thickness dimension of the wipe applicator 100.

The length of the wipe applicator 100 is the maximum dimension measured parallel to the longitudinal centerline L in the longitudinal direction. The width of the wipe applicator 100 is the maximum dimension measured parallel to the transverse centerline T in the transverse direction. The thickness of the wipe applicator is the maximum “z” direction dimension measured parallel to the “z” axis.

When a range or interval is disclosed, the disclosure is intended to disclose both the endpoints and the intervals within the range. For example, a range of 0.005 to 0.010 includes 0.005, 0.006 and 0.010 within that range.

The wipe applicator 100 as shown in FIG. 1A to 1E can have a top side 106 and a bottom side 107. The bottom side 107 can, for most applications, face toward a surface being worked on (not shown). The working face 108 of the wipe 101 can be the bottom-most surface of the wipe applicator 100 as shown in FIG. 1E.

The wipe applicator 100 can incorporate a wipe 101 (which can be more broadly understood as a “pad”), a reservoir 103 and backing 102. The backing 102 can have a handle 104.

The wipe applicator 100 can be used as follows. The liquid 110 in the reservoir 103 can be released by pressing on the dome 111 (part of the first wall 115 of the reservoir 103), as shown in FIG. 1A and inverting the dome 111 as shown in FIGS. 1B and 1E. This can place pressure on the second wall 116 causing it to rupture as shown in FIG. 1E. As the liquid 110 escapes from the reservoir 103, the wipe 101 can become moistened. While the liquid 110 seeps into the wipe 101, the user can fold the handle 104 out as shown in FIG. 1B. The wipe applicator 100 is then ready for use.

The wipe 101 can be made of materials well known in the art of wipes. For many applications, the wipe 101 can be made of a nonwoven fabric. The nonwoven fabric can be a synthetic or a natural material or a combination of synthetic and natural materials. Woven fabrics may also be suitable for other applications. In addition, sponge materials, foams, reticulates, and other materials may be suitable for the wipe 101.

The kind of material used for the wipe 101 will be determined by the application. For use on glass or delicate surfaces, a non-abrasive material such as a soft, nonwoven fabric can be preferable. For use on surfaces where removal of a substance on or in a surface is desirable, a more abrasive material such as a reticulate or coated reticulate for the wipe 101 may be desirable.

The wipe 101 can be laminated with layers (not shown). The layers can allow the wipe 101 to be manufactured using materials with different properties. A wipe with more than two layers (not shown) may also be suitable for some applications.

For many applications, the backing 102 can preferably be a stiffer material than the wipe 101. Various kinds of cardstock can be suitable for most applications. For other applications where a backing 102 with other properties is desirable, other materials such as an injection molded or a thermoformed plastic or even metal backing 102 can be suitable. Alternatively, the backing 102 can be formed as part of the first wall 115 of the reservoir 103.

The reservoir 103 can be created in different ways. For example, the reservoir 103 can have a sandwich construction. The first wall 115 can be made of a material that can be thermoformed to create the dome 111 (also known as a “blister”). A film or foil material can form the second wall 116. As shown in FIG. 1F, the first wall 115 of the reservoir 103 for each wipe applicator 100 can be created from a large sheet 117 of thermoformed plastic. These can be filled with liquid 110 and sealed with the second wall 116. Each reservoir 103 can be die cut from the sheet after the bonding of the first and second walls 115, 116. To make it easier to burst the reservoir 103, the second wall 116 can be weakened along a tear line 109, although this may be unnecessary.

The reservoir 103 can be filled with different liquids 110 (or other flowable materials). These might include liquids 110 that can serve as cleaners or various kinds of substances for coating surfaces such as paints, dyes, stains, protective films, and so forth.

The overall size and shape of the wipe applicator 100 can vary depending on the application. For example, the wipe applicator 100 can be approximately 3 inches long and 2 inches wide and be suitable for applications such as applying a cleaner or an insect repellant to the body (not shown). A smaller sized wipe applicator 100 such as one that is a half inch long and a half inch wide can be suitable for applying various kinds of material to smaller target surfaces such as the finger nails (not shown) or for other small cleaning and application jobs. A larger sized wipe applicator 100 that is 6 inches long and 3.5 inches wide can be appropriate for larger jobs such as cleaning a table surface or windows (not shown). Larger or smaller sized wipe applicators 100 than those described may be suitable for various other applications.

The shape of the wipe applicator 100 and its parts can also vary depending on the application. For example the wipe 101 can be generally rectangular in shape as shown in FIG. 1C. However, other embodiments can include various other shapes including a wipe 101 with round, oval, or polygonal shapes (not shown). In addition, the wipe 101 can have narrowed or pointed areas (not shown) for cleaning or applying coatings more precisely. Finally, the working face 108 of the wipe 101 does not have to be flat. For some applications a more spherical shape creating, for example, a curved profile (not shown) can be preferable. Other applications may call for a working face 108 with various kinds of relief (not shown) that change the characteristics of the working face 108 of the wipe 101. For example, a wipe 101 with a working face 108 having ridges (not shown) of various kinds can be suitable for some applications.

The manufacture of the wipe applicator 100 can be accomplished in a variety of ways. For many applications, it can be preferable to have some or all of the cutting and assembly of the wipe applicator 100 completed using a web converting process. The thermoforming and sealing of the reservoirs 103 can be accomplished in a earlier step or in a separate process. The wipe applicator 100 can be packaged in-line using, for example, flow wrap packaging or other forms of packaging.

The various components of the wipe applicator 103 can be attached to each other using various means. For example, adhesive can be used to attach a surface or portions of a surface to another layer. Other methods such as those using heat can also bond layers together. Mechanical fasteners such as rivets (made of plastic, for instance) can also fasten the layers together. Whatever fastening method is used, it can be applied such that it does not interfere with the release of the liquid from the reservoir. For example, adhesive can be applied such that it is not applied in the area surrounding the tear line. This can ensure that the reservoir 103 breaks along the tear line 109 when pressure is exerted on the reservoir 103.

The wipe applicator 100 as disclosed above can have many uses and can offer several advantages. First, the wipe applicator 100 can be used in instances in which the user does not wish to contact the wipe 101 directly with the user's hands. This might include instances where the user is using a wipe 101 saturated with harsh chemicals such as various kinds of solvents. However, it can also include a wipe 101 saturated with milder chemicals such as diluted alcohol or cleaners that can dry the hands or paints or dyes that can color the hands. In addition, a user may wish to use her or his hands to handle food (not shown) after use of a wipe 101. Many substances such as insect repellant and sunscreen can impart a bad taste to food, and the user may wish to avoid contaminating food with them. The wipe applicator 100 permits the user to keep such substances from coming in contact with the hands and hence with food.

Second, the handle 104 on the wipe applicator 100 can provide a convenient way to hold and control the wipe 101. Many wipes in the prior art (not shown) are simply a folded sheet or a ball of cotton or synthetic fibers. It can often be difficult to apply substances evenly to surfaces with such devices in the prior art. In addition, holding onto prior art wipes as a user moves them across a surface can be difficult. This can be especially true on rougher surfaces or as the wipe dries. The handle 104 for the wipe applicator 100 makes use of the wipe 101 much easier under such circumstances.

Third, the wipe applicator 100 can be rapidly prepared for use. The only step of preparation necessary for the wipe applicator 100 can be pressing the dome to release the liquid into the wipe. With individually packaged prior art wipes (not-shown), the packaging has to be opened, the wipe removed from the packaging, and the wipe unfolded. The unfolding of such prior art wipes can be particularly difficult given the relative thinness of many wipes in the prior art. The wipe applicator 100 can overcome these and other problems and allow for rapid deployment of the wipe 101 .

Fourth, the wipe applicator 100 can avoid many of the problems of bulk packed, pre-moistened wipes (i.e., wipes not packaged individually) of the prior art. Bulk packed, pre-moistened wipes of the prior art are often stored in canisters or tubs (not shown). Such large containers can be inconvenient to store and take along in a pocket, purse, backpack or briefcase. In addition, even within one container, the bulk packed pre-moistened wipes of the prior art can vary in how saturated they are. Some can be very moist while others are drier. This often results from inadequate distribution of fluid in the container before the wipe of the prior art is dispensed. The individualized portions 110 of the wipe applicator 100 can overcome such problems.

Other embodiments can have different features than those described above. Some of those other features are discussed below.

### Second Embodiment

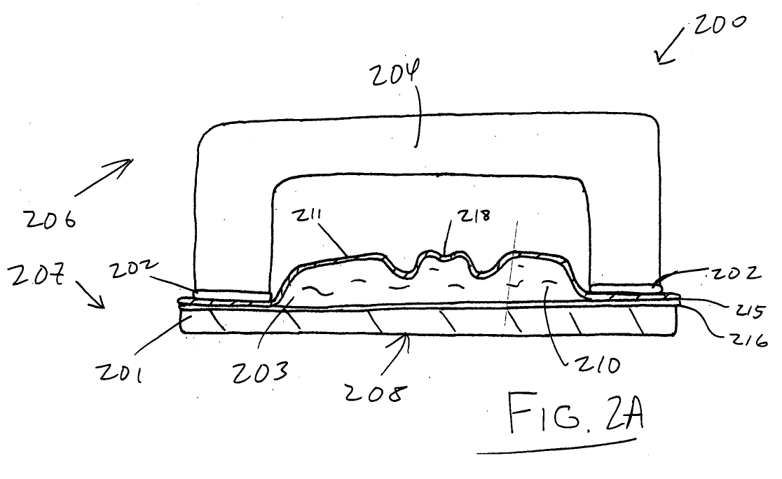

FIG. 2A shows a wipe applicator 200 according to a second embodiment. The wipe applicator 200 can substantially resemble the wipe applicator 100 shown in relation to FIG. 1A to 1F with at least the differences described below.

The first wall 215 of the reservoir 203 can be shaped into a pressure point 218 as shown in FIG. 2A. This pressure point 218 (shaped this way or in other ways not shown) can exert more pressure on the second wall 216 of the reservoir 203 and make breaking the second wall 216 and the release of the liquid 210 easier.

### Third Embodiment

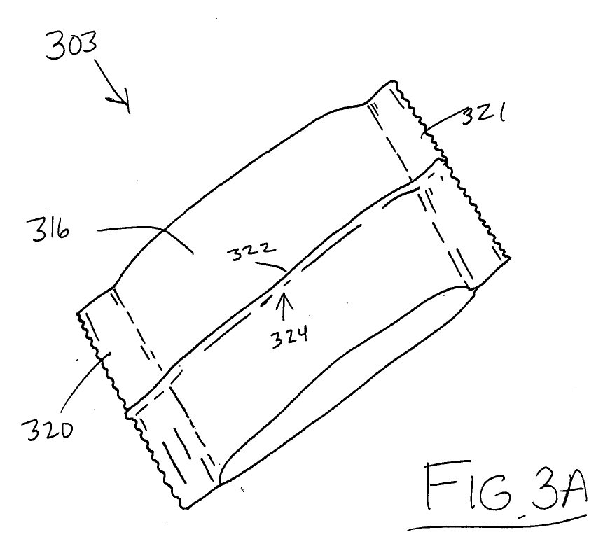

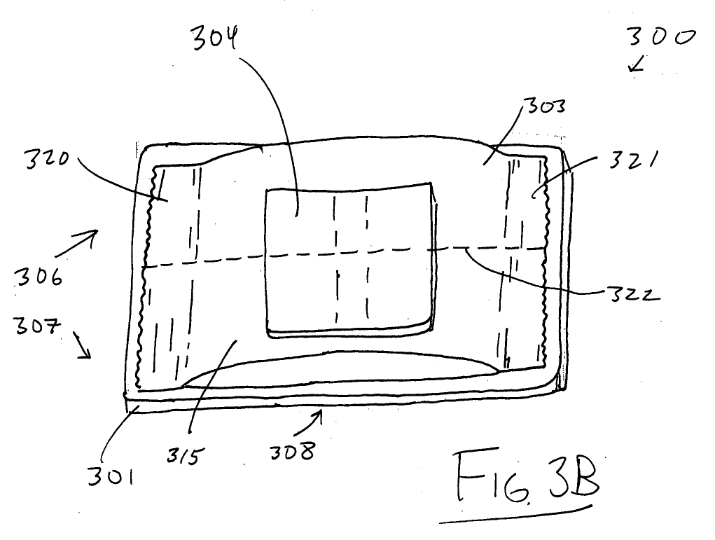

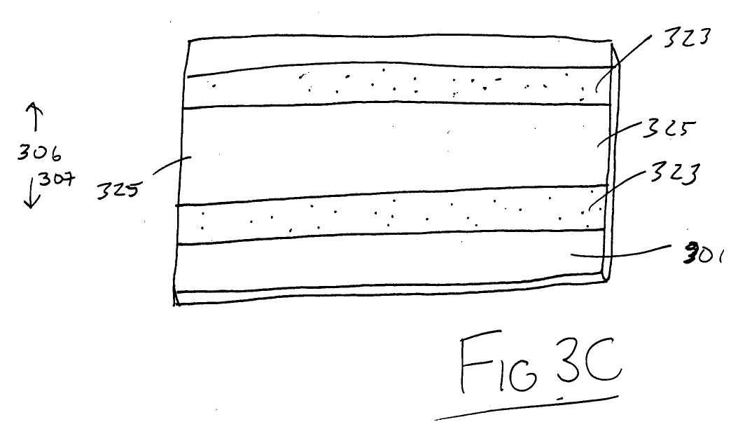

FIGS. 3A to 3C show a wipe applicator 300 according to a third embodiment. The wipe applicator 300 can substantially incorporate many of the elements of the first and second embodiments. The wipe applicator 300 can have these differences.

The reservoir 303 can be made of a pouch. For example, the reservoir 303 can be of a type used in flow-wrap packaging. The reservoir 303 can have two end seams, 320, 321, and a lengthwise seam 322. The first wall 315 of the reservoir 303 can be positioned upward and away from the wipe 301. The second wall 316 with the lengthwise seam 322 can be positioned downward and can contact the wipe 301 directly. By pressing on the first wall 315, pressure can be exerted on the reservoir 303. The lengthwise seam 322 can be sufficiently weak that it can break under the pressure. This can allow liquid 310 in the reservoir 303 to leak out onto the wipe 301. Any fastening method used, such as adhesives, should be used in such a fashion that it does not interfere with the release of the liquid 310 through the lengthwise seam 322. FIG. 3C shows two strips of adhesive 323 that can be positioned on either side of the lengthwise seam 322. So long as the lengthwise seam 322 is weakened toward the middle 324 of it and the wipe applicator 300, liquid 310 should not seep out the area between the strips of adhesive 323.

The third embodiment does not have backing. The wipe applicator 300 can simply have a handle 304 affixed to the first wall 315 of the reservoir 303. This handle 304 can also be eliminated (not shown) although this could make handling the wipe applicator 300 more difficult.

An advantage of the wipe applicator 300 according to the third embodiment can be the economy of manufacturing it. This can be due to the simple construction of the reservoir 303.

In addition, because the wipe applicator 300 according to the third embodiment does not have backing, the wipe applicator 300 can be more flexible and can be used on a variety of surfaces.

### Fourth Embodiment

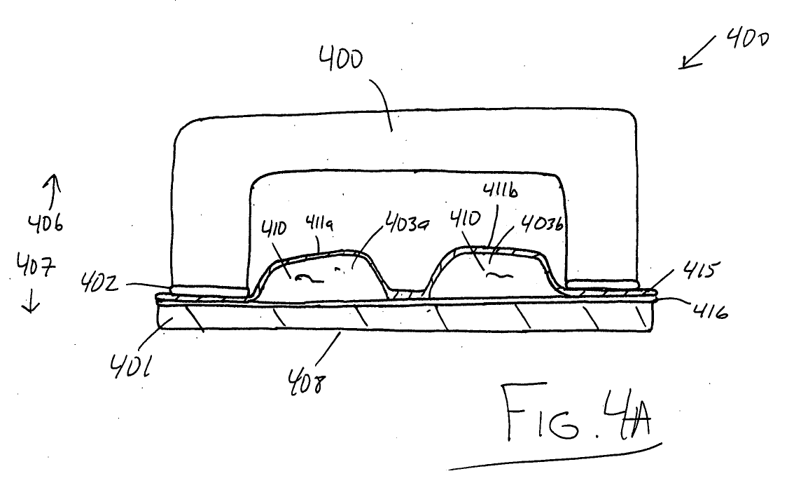

FIG. 4A shows a wipe applicator 400 according to a fourth embodiment. The wipe applicator 400 can substantially incorporate many of the elements of the first and second embodiments. It can have these differences.

The wipe applicator 400 can have a first reservoir 403a and a second reservoir 403b. This can allow liquid 410 to be released from the first reservoir 403a. The wipe applicator 400 can then be used. The second reservoir 403b can,be used to replenish the wipe 401 later after the wipe 401 dries from use. Having two reservoirs 403a, 403b can extend use of the wipe applicator 400.

Other embodiments can have more than two reservoirs. In addition, other embodiments can be constructed such that different materials can be stored in the separate reservoirs 403a, 403b. The different materials could be mixed when the liquid 410 in each reservoir is released.

### Fifth Embodiment

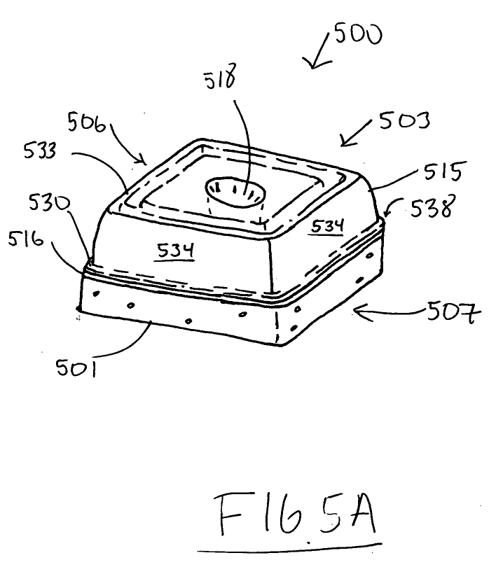

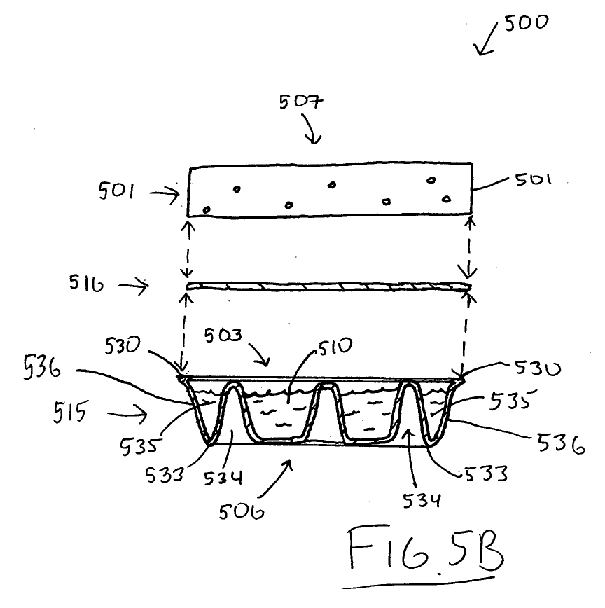

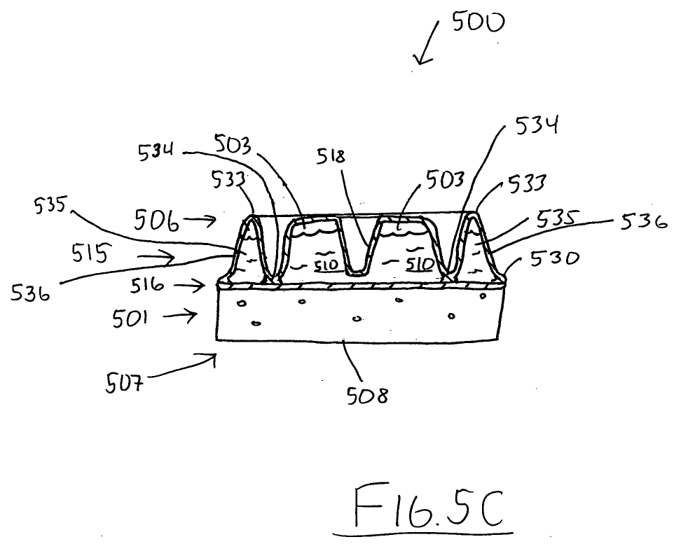

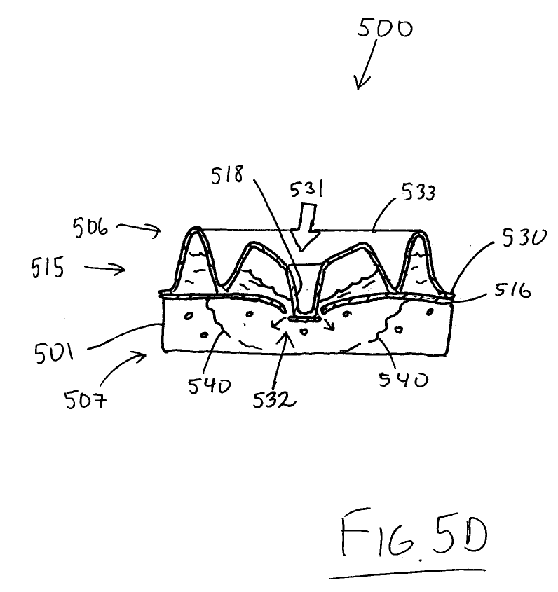

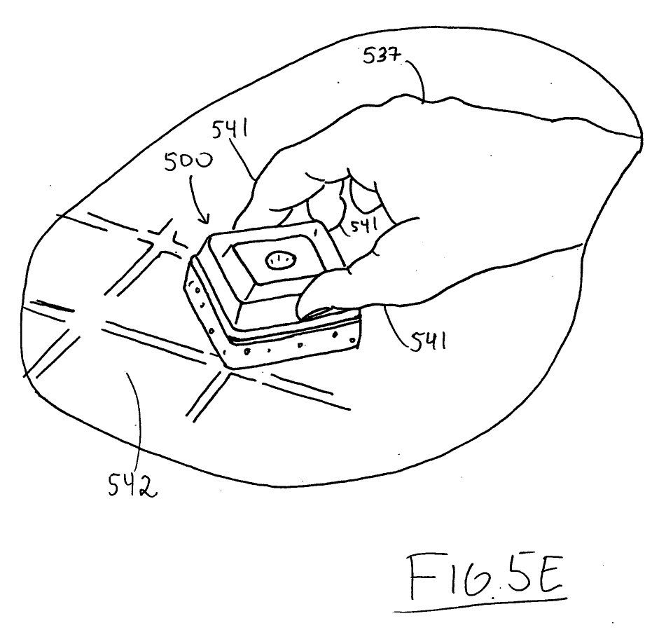

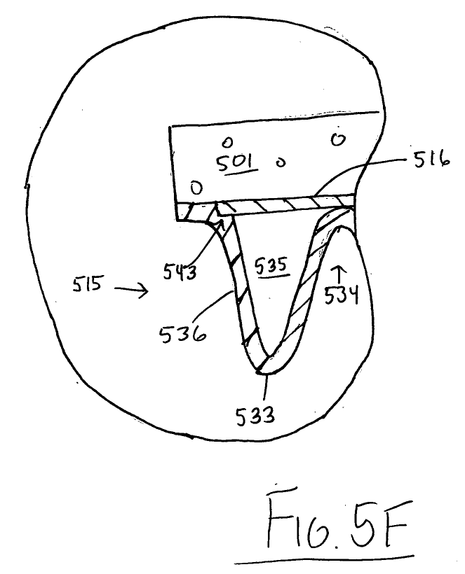

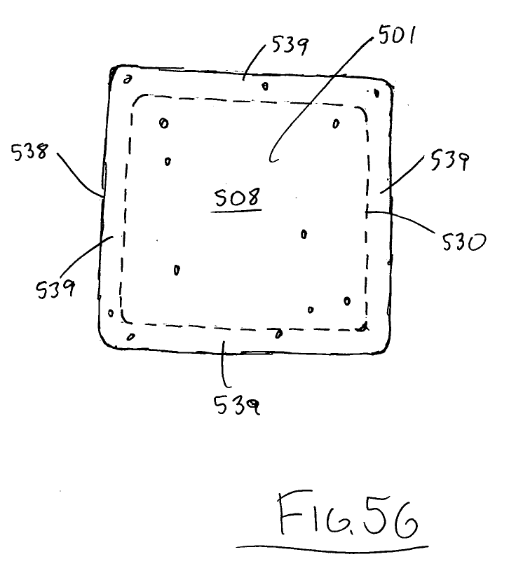

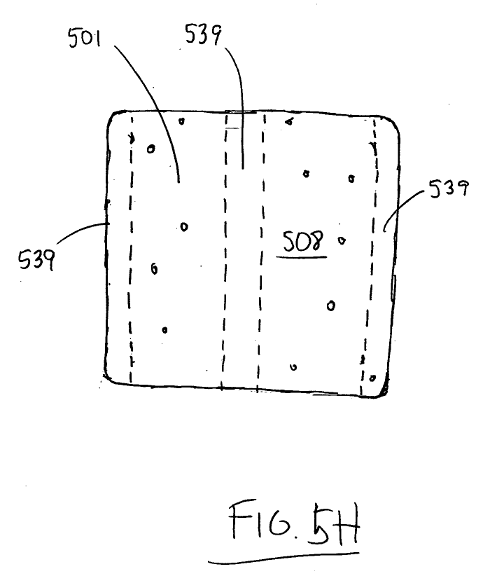

FIGS. 5A to 5H show a wipe applicator 500 according to a fifth embodiment. The wipe applicator 500 can incorporate aspects of the wipe applicator 100 shown in relation to FIG. 1A to 1F, the wipe applicator shown in relation to FIG. 2A, the wipe applicator shown in relation to FIG. 3A to 3C, or the wipe applicator shown in relation to FIG. 4A.

Among other things, the wipe applicator 500 can be used as shown in FIG. 5E for cleaning, scrubbing, painting, staining, or otherwise treating surfaces. After the wipe applicator 500 is activated, as discussed below, the wipe applicator 500 can be held by the fingers 542 or hand 541 as shown. The vertical portions 536 can permit a user to control the wipe applicator 500 for wiping, scrubbing, scouring, and so forth. The motions (not specifically identified in the illustrations) can include movements back-and-forth, in circular patterns, dabbing motions, pressure motions (that press the wipe 101 onto a surface), or combinations of these and other movements.

For many applications, a wipe applicator 500 that is approximately 1.5 in. long, 1.5 in. wide, and 0.75 in. high (i.e., thickness or height including the wipe 101) can be preferable for certain applications such as one requiring some scrubbing or wiping. However, smaller or larger sizes can be preferable depending on the application.

The wipe applicator 500 can comprise a reservoir 503 and a wipe 101. The reservoir can comprise a formed structure 515 and a wall 516. The wall 516 can be attached to the formed structure 515 along the flange 530 at the periphery 538 of the formed structure 515. For example, an adhesive or other bond can attach the wall 516 to the flange 530 as shown in FIG. 5G. The bond can ensure that liquid does not leak prematurely from the reservoir 503.

The wipe 101 can form a third layer that can be combined with the wall 516 and the formed structure 515 as shown in FIG. 5B. The wipe 101 can attach at the periphery 538 to the flange 530 as shown in FIG. 5G. Alternatively, the wipe 101 can be attached with an adhesive or other bond along the lines 539 shown in FIG. 5H.

The formed structure 515 can incorporate a pressure member 518 (shaped this way or in other ways not shown). By applying downward pressure 531 on the top 506 of the reservoir 503 as shown in FIG. 5D, the pressure member 518 can be pressed into the wall 516. The downward pressure 531 against the wall 516 can break the wall 516 or break the seam formed at the flange 530 allowing the liquid 510 to soak 540 into the wipe 501.

The formed structure 515 can also incorporate a ridge 533. The ridge 533 can serve several purposes. The ridge 533 can have vertical portions 536 that can be grasped as shown in FIG. 5E. The ridge 533 can also help form a channel 534. The channel 534 can serve to help the reservoir collapse as shown in FIG. 5D.

FIGS. 5B to 5D show the liquid 510 in the ridge cavity 535. The wall 516 can be preferably be bonded to the formed structure 515 at the flange 530, thus allowing liquid to flow into the ridge cavity 535. However, the wall 516 could also be bonded to the formed structure 515 at both the flange 530 and the bottom of the channel 534. Alternatively, the wall 516 could be bonded solely at the base of the channel 534, although this would be the least preferable for most applications.

The formed structure 515 can be shaped or formed in many different ways. For example, the formed structure 515 can be shaped as a blister using methods using methods such as cold forming or thermoforming. The pressure member 518 can in this way be formed as a hollow segment of a cone (although the pressure member 518 can be formed into many other shapes as well (not shown)).

Materials for cold forming can include, for example, cold form foil (CFF). Materials for thermoforming can include thermoplastics such as Polyethylene (PE), High Density Polyethylene (HDPE), Polyethylene Terephthalate (PET), Polyvinyl Chloride (PVC), Polyvinyl Dichloride (PVdC), Polypropylene (PP), Polystyrene (PS), Cyclic Olefin Copolymer (COC), or ACLAR.™ Such manufacturing processes and materials can be economical. However, the formed structure 515 can be shaped in many other ways such as, for example, by compression, injection, or blow molding. Many other kinds of materials can be used in such a manufacturing process.

The wall 516 can preferably be a sheet material such as foil, film, or laminated materials that can comprise layers (not shown) of foils, films, or materials. For many applications a relatively thin foil of a thickness of .0008 in. or .001 in. can be suitable. A “push-through foil” that can be burst when subjected to the requisite pressure 531 described above can be preferable for most applications.

The formed structure 515 and the wall 516 can be attached to each other in various ways. Various kinds of adhesives or other bonding methods such as heat sealing can be used. For a stronger seal between the formed structure 515 and the wall 516, the flange 530 can be wider.

The wipe 501 can be made of various materials including those discussed above including nonwoven textiles, woven textiles, foams, polyester reticulates and combinations of these and other materials. For most applications, a wipe that is hydrophilic can be preferable because it can draw the liquid 510 from the reservoir and remain saturated during use. The wipe 501 can be attached to the wall 516 using various kinds of adhesives or other bonding methods such as heat sealing. Other methods, some of which are discussed in relation to other embodiments, can also be used.

The manufacturing process of the wipe applicator 500 can proceed as follows. The formed structure 515 can be formed as part of an array (not shown but resembling to the one shown in FIG. 1F). The inverted reservoir 503 as shown in FIG. 5B can be filled with liquid 510. The wall 515 can be attached to the formed structure 516. The wipe 501 can be attached to the wall 516. Each wipe applicator 500 can then be cut from the array (not shown) using a die cutter or other cutting means. Alternatively, a perforation (not shown) can be made the periphery 538 of each wipe applicator 500. The wipe applicator 500 can be packaged as part of an array (not shown), and the consumer can tear off the individual wipe applicator 500.

Many other manufacturing methods with different attachment configurations are also possible. For example, the flange 530 can be shaped as shown in FIG. 5F with a recess 543 into which the wall 516 can seat. In this configuration the wipe 501 can be affixed either to the formed structure 515 (without being affixed to the wall 516) or can be affixed to both the formed structure 515 and to the wall 516.

Finally, the order in which the formed structure 515, the wall 516, and the wipe 501 are attached to each other can differ. For example, as stated above, the formed structure 515 and the wall 516 can first be attached to each other during assembly. Next, the wipe 501 can be attached. Alternatively, the wipe 501 can first be attached to the formed structure 516 and then the wall 516 and wipe 501 as a laminated sheet can be attached to the formed structure 515.

The wipe applicator 500 as shown can have several advantages over the prior art. First, the formed structure 515 can be formed into a box-like shape with the vertical portions 536 of the ridge 533 functioning as convenient gripping surfaces as shown in FIG. 5E. This can obviate the need for an additional handle which can make manufacture more efficient and economical.

Second, the stiffness of the formed structure 515 can be varied depending on the application. For example, for scrubbing or other kinds of hard use, the backing can be made of thicker material. For more delicate uses or where surfaces may be less flat, a more forgiving material can be used for the formed structure 515.

Third, the channel 534 and the ridge 533 can increase the deflection (up and down) of the pressure member 518. This can help ensure that downward pressure 531 on the top of the reservoir 503 can cause the pressure member 518 to break the wall 516. Additional features (not shown) such as additional channels can permit an increase in downward pressure 531 should it be necessary.

### Sixth Embodiment

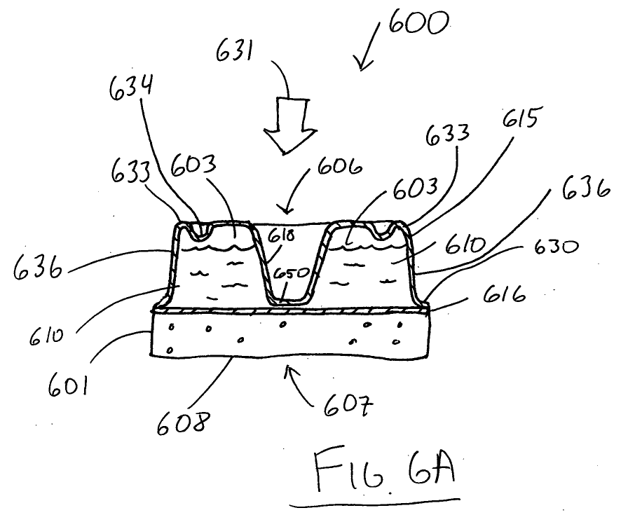

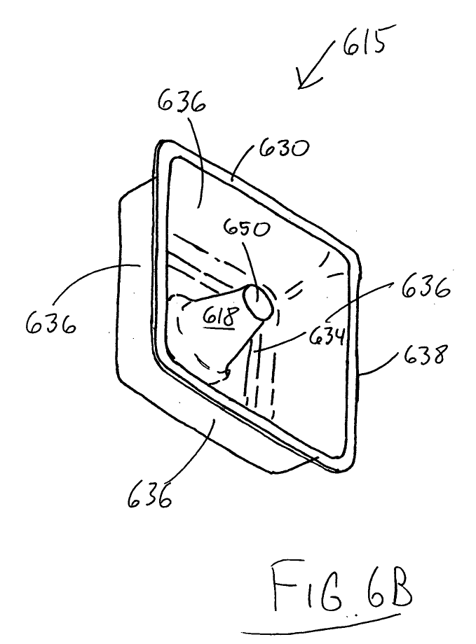

FIGS. 6A to 6B show a wipe applicator 600 according to a sixth embodiment. The wipe applicator 600 can incorporate aspects of the wipe applicator 100 shown in relation to FIG. 1A to 1F, the wipe applicator 200 shown in relation to FIG. 2A, the wipe applicator 300 shown in relation to FIG. 3A to 3C, the wipe applicator 400 shown in relation to FIG. 4A, or the wipe applicator 500 shown in relation to FIGS. 5A to 5E.

The wipe applicator 600 can comprise a formed structure 615, a wall 616, and a wipe 601. The wipe applicator can be constructed in much the same way as the wipe applicator 500 discussed in relation to FIGS. 5a to 5F. However, there can be some differences.

The formed structure 615 can be formed to have vertical portions 636. A person can hold the wipe applicator 600 by the vertical portions 636 of the formed structure 515 when using the applicator 600 to apply the liquid 610 (The applicator 600 can be held in a manner similar to the one shown in FIG. 5E).

The wipe applicator 600 as shown can have several advantages. First, the configuration can allow for greater maximization of the reservoir 603 area with a decrease in the amount material used to create the formed structure 615. With this embodiment, the reservoir 603 can hold a substantial amount of liquid 610.

Second, the formed structure 615 can be relatively easy to form since it has fewer features in its surface. For example, the channel 634 can be shallower.

Third, the vertical portions 636 can be nearly vertical, i.e., the draft angle in the mold (not shown) for forming the formed structure can approach zero degrees. For example, if the formed structure 615 has a height (or thickness) of approximately 0.5 in., the vertical portions 636 can be formed from a mold with a draft angle of less than one deg. and preferably 0.5 deg. or less. Having the vertical portions 636 formed from a mold with a low draft angle can permit the vertical portions 636 to be closer to absolutely vertical making the wipe applicator 600 easier to control.

Fourth, as shown in FIG. 6A, the bottom end 650 of the pressure member 618 can extend even with the flange 630 (or. even, in some applications below it as shown in FIG. 6A). When the wall 616 is attached to the flange 630, this can bring the bottom end 650 nearly in contact or in contact with the wall 616. This can permit the application of greater pressure on the wall 616 making the bursting of the wall 616 easier. In addition, a bond such as one with adhesives can also be formed between the bottom end 650 and the wall 616. This could further enhance the ability of the pressure member 618 to burst the wall 616.

### Seventh Embodiment

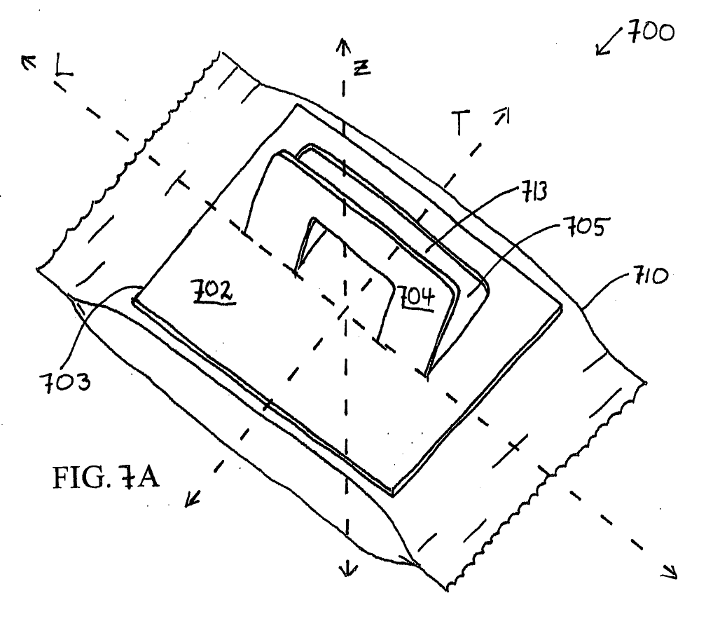

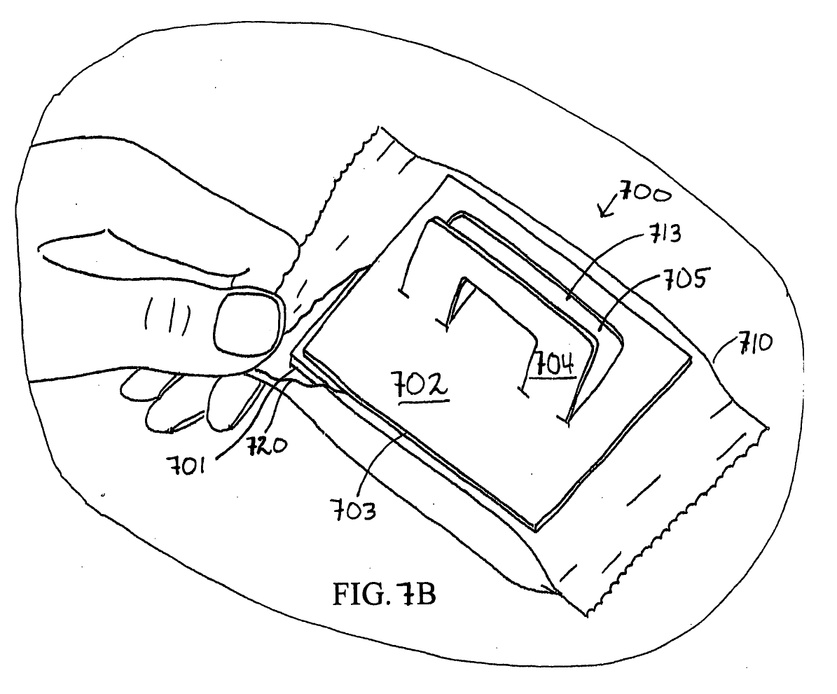

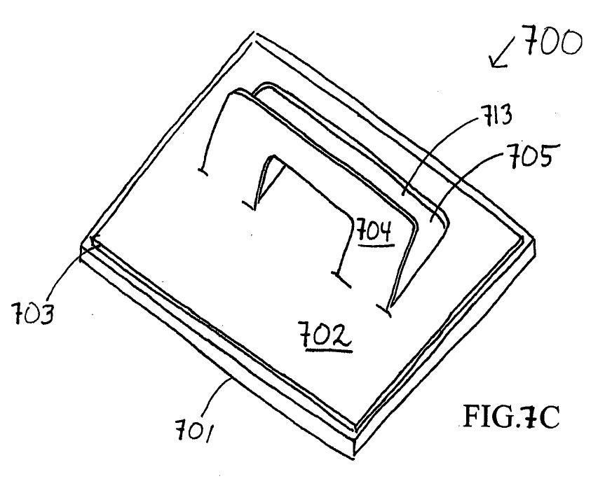

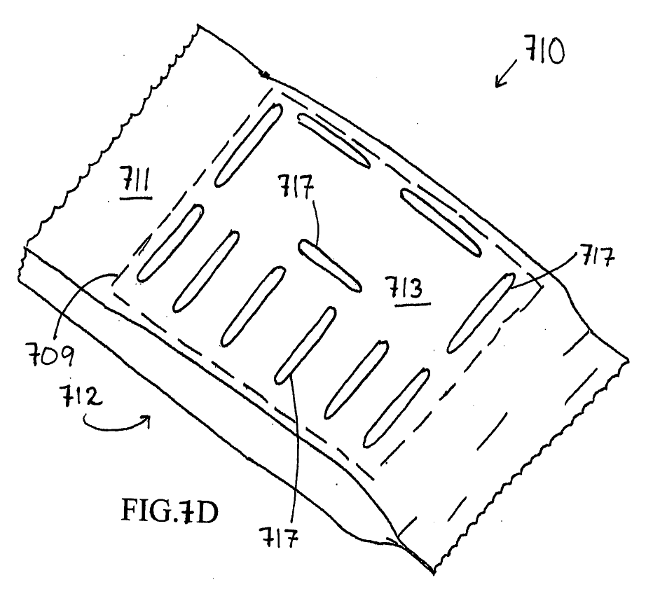

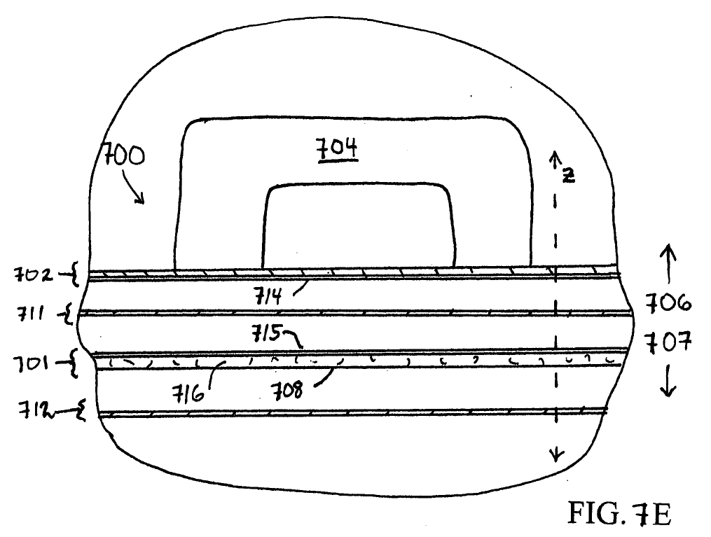

The wipe holder 700 (and the packaging) shown in FIGS. 7A to 7E can be oriented with a longitudinal centerline L generally bisecting the wipe holder 700. The term “longitudinal” refers to a line, axis, or direction in the plane of the wipe holder 700 that is aligned with the centerline L. The wipe holder shown in FIG. 7A can further be oriented with a transverse (or lateral) centerline T that is perpendicular to the longitudinal centerline L. The term “transverse” refers to a line, axis, or direction in the plane of the wipe holder 700 that is aligned with the centerline T. The wipe holder 700 can further be oriented with a line z as shown in FIGS. 7A to 7E, which is perpendicular to the plane formed by centerlines L and T and generally corresponds to the direction associated with the thickness dimension of the wipe holder 700.

The length of the wipe holder 700 is the maximum dimension measured parallel to the longitudinal centerline L in the longitudinal direction. The width of the wipe holder 700 is the maximum dimension measured parallel to the transverse centerline T in the transverse direction. The thickness of the wipe holder is the maximum “z” direction dimension measured parallel to the “z” axis.

When a range or interval is disclosed, the disclosure is intended to disclose both the endpoints and the intervals within the range. For example, a range of 0.005 to 0.010 includes 0.005, 0.006 and 0.010 within that range.

The wipe holder 700 as shown in FIG. 7A to 7E can have a top side 706 and a bottom side 707. The bottom side 707 can, for most applications, face toward a surface being worked on (not shown). The working face 708 of the wipe 701 can be the bottom-most surface of the wipe holder 700 as shown in FIG. 7E.

The wipe holder 700 can incorporate a wipe 701(which can be more broadly understood as a “pad”) and backing 702. The backing 702 can have a handle 704. The wipe holder 700 can be packaged and sealed in liquid impermeable packaging 710 as shown in FIG. 7A. A portion of the top wall 711 of the packaging 710 can be sandwiched between the backing 702 and the wipe 701. This sandwiched portion 713 of the top wall 711 can be attached to the backing 702 (and attached to the wipe 701 as discussed below) by adhesive 714 or other attachment means. The user can remove the wipe holder 700 from the packaging 710 by tearing 720 the packaging 710 off as shown in FIG. 7B approximately along a tear line as shown in FIG. 7D. The sandwiched portion 713 of the packaging 710 can remain between the wipe 701 and the backing 702 after the packaging 710 is torn away as shown in FIG. 7B. Part of the sandwiched portion 713 can be visible through the handle opening 705.

Once removed from the packaging 710, the wipe holder 700 can, as shown in FIG. 7C, be ready for use. For example, the user can grasp (not shown) the handle 704 and use the wipe holder 700 to apply a cleaner to the skin (not shown) by directing the working face 708 of the wipe 701 toward the skin or other target surface (not shown).

The wipe 701 can be made of materials well known in the art of wipes. For many applications, the wipe 701 can be made of a nonwoven fabric. The nonwoven fabric can be a synthetic or a natural material or a combination of synthetic and natural materials. Woven fabrics may also be suitable for other applications. In addition, sponge materials, foams, reticulates, and other materials may be suitable for the wipe 701.

The kind of material used for the wipe 701 will be determined by the application. For use on glass or delicate surfaces, a non-abrasive material such as a soft, nonwoven fabric can be preferable. For use on surfaces where removal of a substance on or in a surface is desirable, a more abrasive material such as a reticulate or coated reticulate for the wipe 701 may be desirable. If the wipe 701 is to be saturated or pre-moistened, some portion of the wipe 701 should preferably absorb and retain liquids. For such purposes, a an absorbent foam or a fabric may be preferable.

As shown in FIG. 7E, the wipe 701 can be laminated with layers 715, 716. The layers 715, 716 can allow the wipe 701 to be manufactured using materials with different properties. A wipe with more than two layers (not shown) may also be suitable for some applications.

The wipe 701 can also be saturated with different liquids. (Liquids are not identified in the drawings). These might include liquids that can serve as cleaners or various kinds of substances for coating surfaces such as paints, dyes, stains, protective films, and so forth. The wipe 701 can remain in a saturated form when packaged or a solution can be dried on the wipe 701 leaving a solid (not shown) which can be released when liquid is supplied, for example, by the user. In addition, pastes or other semi-solids can be applied to the wipe 701.

Alternatively, the wipe 701 can be manufactured without the addition of fluids, semi-solids, or solids. Such a wipe 701 can be used in a dry form, such as for dusting. Alternatively, a dry wipe 701 can be used in a wet environment or can have a liquid added to the wipe by the user.

The wipe 701 shown in FIG. 7E with its two layers 715, 716 can have advantages. The wipe 701 can have the first layer 715 saturated with a fluid during manufacture. The second layer 716 can be liquid impermeable. The second layer 716 can prevent moisture from, soaking through the wipe 701 and coming in contact with the user, for example, through the handle opening 705. In addition, the second layer 716 can be made of a material compatible with an adhesive 714.

For many applications, the backing 702 can preferably be a stiffer material than the wipe 701. Various kinds of cardstock can be suitable for most applications. For other applications where a backing 702 with other properties is desirable, other materials such as an injection molded or a thermoformed plastic or even,metal backing 702 can be suitable.

The packaging 710 can be made of different materials that have different properties. For many applications, the packaging 710 can preferably be a thermoplastic film suitable for flow-pack type packaging. Other forms of packaging 710 can also be suitable depending on the application.

To ease removal of the packaging 710 from the wipe holder 700 as discussed above, certain features can be added to the packaging 710. For example, the packaging 710 can be weakened along a tear line 709 that generally conforms to the backing periphery 703. The tear line 709 can be created, for example, by stressing (e.g., with heat or pressure) or perforating the packaging 710 along the tear line 709. Alternatively, tear tape (not shown) can be employed to remove or start the removal the packaging 710 from the wipe holder 700. Finally, if the packaging 710 is sufficiently thin and tear-able, the packaging 710 can simply be torn, and the tear can generally follow the tear line 709. A strong bond between the backing 702, the sandwiched portion 713 of the packaging 710, and the wipe 701 can help ensure a tear follows the tear line 709.

The overall size and shape of the wipe holder 700 can vary depending on the application. For example, the wipe holder 100 can be approximately 3 inches long and 2 inches wide and be suitable for applications such as applying a cleaner or an insect repellant to the body (not shown). A smaller sized wipe holder 700 that is a half inch long and a half inch wide can be suitable for applying various kinds of material to smaller target surfaces such as the finger nails (not shown) or for other small cleaning and application jobs. A larger sized wipe holder 700 that is 6 inches long and 3.5 inches wide can be appropriate for larger jobs such as cleaning a table surface or windows (not shown). Larger or smaller sized wipe holders 700 than those described may be suitable for various other applications.

The shape of the wipe holder 700 and its parts can also vary depending on the application. For example the wipe 701 can be generally rectangular in shape as shown in FIG. 7C. However, other embodiments can include various other shapes including a wipe 701 with round, oval, or polygonal shapes (not shown). In addition, the wipe 701 can have narrowed or pointed areas (not shown) for cleaning or applying coatings more precisely. Finally, the working face 708 of the wipe 701 does not have to be flat. For some applications, for example, a more spherical shape creating, for example, a curved profile (not shown) can be preferable. Other applications may call for a working face 708 with various kinds of relief (not shown) that change the characteristics of the working face 708 of the wipe 701. For example, a wipe 701 with a working face 708 having ridges (not shown) of various kinds can be suitable for some applications.

The manufacture of the wipe holder 700 can be accomplished in a variety of ways. For many applications, it can be preferable to have some or all of the cutting and assembly of the wipe holder 700 completed using a web converting process. In addition, the wipe holder 700 can be packaged in-line using, for example, flow wrap packaging.

In a web converting process, the wipe holder 700 can generally be manufactured as conventional wipes are manufactured. In addition, openings 717 can be cut in the top wall 711 of the packaging 710. During manufacture, the adhesive 714 on the backing 702 can be attached both to the sandwiched portion 713 of the packaging 710 and (through the openings 717 several of which are identified in FIG. 7D) to the wipe 701. If the wipe 701 is to be moistened, fluid can be injected into the packaging 710 after the backing 702 has been attached with the adhesive 714 to the wipe 701.

Alternatively, the wipe holder 700 can be constructed and manufactured in other ways. Although a web converting process is described above, various manufacturing techniques including assembly by hand can also be suitable. Bonding techniques other than adhesives can be used. For example, heat can be used to melt layers together or mechanical fasteners can be used to fasten components together. Such modifications are still within the scope of this invention.

The wipe holder 700 as disclosed above can have many uses and can offer several advantages. First, the wipe holder 700 can be used in instances in which the user does not wish to contact the wipe 701 directly with the user's hands. This might include instances where the user is using a wipe 701 saturated with harsh chemicals such as various kinds of solvents. However, it can also include a wipe 701 saturated with milder chemicals such as diluted alcohol or cleaners that can dry the hands or paints or dyes that can color the hands. In addition, a user may wish to use her or his hands to handle food (not shown) after use of a wipe 701. Many substances such as insect repellant and sunscreen can impart a bad taste to food, and the user may wish to avoid contaminating food with them. The wipe holder 700 permits the user to keep such substances from coming in contact with the hands and hence with food.

Second, the handle 704 on the wipe holder 700 can provide a convenient way to hold and control the wipe 701. Many wipes in the prior art (not shown) are simply a folded sheet or a ball of cotton or synthetic fibers. It can often be difficult to apply substances evenly to surfaces with such devices in the prior art. In addition, holding onto prior art wipes as a user moves them across a surface can be difficult. This can be especially true on rougher surfaces or as the wipe dries. The handle 704 for the wipe holder 700 makes use of the wipe 701 much easier under such circumstances.

Third, the wipe holder 700 can be rapidly prepared for use. The only step of preparation necessary for the wipe holder 700 can be the removal of the packaging 710 by tearing it off along the tear line 709. With individually packaged prior art wipes (not shown), the packaging has to be opened, the wipe removed from the packaging, and the wipe unfolded. The unfolding of such prior art wipes can be particularly difficult given the relative thinness of many wipes in the prior art. The wipe holder 700 can overcome these and other problems and allow for rapid deployment of the wipe 701.

Fourth, the wipe holder 700 can avoid many of the problems of bulk packed, pre-moistened wipes (i.e., wipes not packaged individually) of the prior art. Bulk packed, pre-moistened wipes of the prior art are often stored in canisters or tubs (not shown). Such large containers can be inconvenient to store and take along in a pocket, purse, backpack or briefcase. In addition, even within one container, the bulk packed pre-moistened wipes of the prior art can vary in how saturated they are. Some can be very moist while others are drier. This often results from inadequate distribution of fluid in the container before the wipe of the prior art is dispensed. The individualized packaging 710 of the wipe holder 700 can overcome such problems.

Other embodiments can have different features than those described above. For example, in the embodiment discussed above, the wipe 701 can attach to the backing 702 through openings 717 in the top packaging wall 711. In another embodiment (not shown) the openings 717 could be eliminated and the wipe 701 could be attached directly to the bottom side 707 of the top wall 711 of the packaging 710. The attachment could be effected by making layer 715 adhesive. Adhesive 714 could attach the backing to the top side 706 of the top wall 711 of the packaging 710. In this fashion, the sandwiched portion 713 of the packaging 710 could be sandwiched by adhesive 714 and 715 between the backing 702 and the wipe 701.

Many other embodiments can have still other features. Some of those other features are discussed below.

### Eighth Embodiment

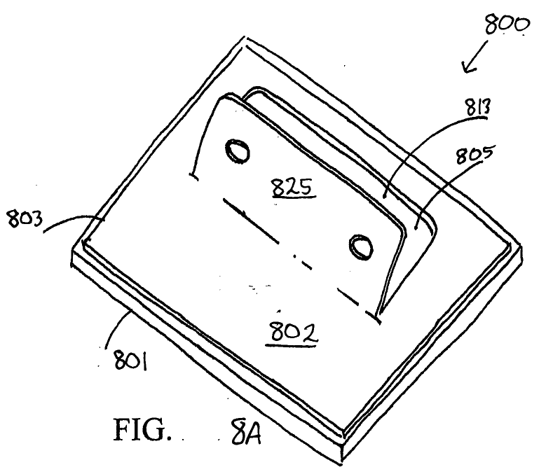

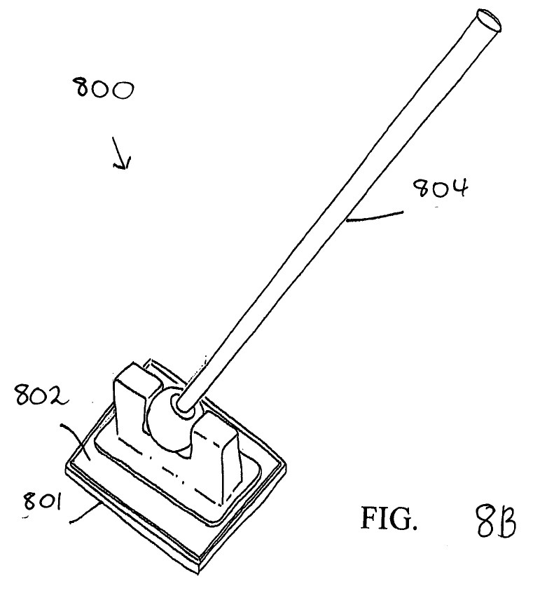

FIGS. 8A to 8B show a wipe holder 800 according to a second embodiment. The wipe holder 800 can substantially resemble the one shown in relation to FIG. 1A to 1E with at least these differences. The wipe holder 800 can have a releasably connected handle 804. The handle 804 can releasably connect to a mount 825 on the wipe holder 800.

The handle 804 can be of various lengths. For example, a handle 804 that is approximately 4 to 12 inches in length can be suitable for smaller jobs such as cleaning glass such as the windshield or the dashboard of a vehicle (not shown). A handle 804 of greater length, approximately 36 to 50 inches, can be suitable for use in cleaning floors, stairs, and so forth.

Correspondingly, the wipe 801, backing 802, and any packaging (not shown) can be of various sizes. For use on a windshield, for example, the wipe 801 and backing 802 can preferably be approximately 4 inches long and 2 inches wide. For use with a longer handle 804 as a mop, the wipe 801 and backing 802 can preferably be approximately 10 inches long and 4 inches wide. Other sizes and lengths for the handle 804, the wipe 801, the backing 802, and other components could be suitable for other applications.

Various parts of the wipe holder 800 can be reusable. For example, the handle 804 can preferably be reusable, especially for embodiments using a longer handle 804. For such applications, the wipe 801 and backing 802 can preferably be disposable or be of short-term reusability.

### Modifications

The embodiments or examples discussed above can be combined in various ways without departing from the invention. Moreover, the present invention should not be considered limited to the particular examples described above, but rather should be understood to cover all aspects of the invention as fairly set out in the claims arising from this application. For example, while suitable sizes, materials, packaging and the like have been disclosed in the above discussion, it should be appreciated that these are provided by way of example and not of limitation as a number of other sizes, materials, fasteners, and so forth may be used without departing from the invention. Various modifications as well as numerous structures to which the present invention may be applicable will be readily apparent to those of skill in the art to which the present invention is directed upon review of the present specifications. The claims which arise from this application are intended to cover such modifications and structures.

We claim:

1. An applicator comprising: a receptacle having walls that form an interior and an exterior, having a projection extending from at least one wall into the interior and toward an opening in the receptacle; a fluid contained in the receptacle; a barrier having a first side and a second side with the first side affixed to the receptacle to seal the opening; and a pad permanently affixed to the second side of the barrier.

2. A method for releasing fluid from an applicator comprising the steps of: applying force to an exterior surface of a receptacle; forcing a projection extending from the wall of the receptacle into a barrier, which barrier seals an opening in the receptacle; causing a rupture in the barrier with the projection; releasing a fluid through the rupture into a pad permanently affixed to the barrier.

3. An applicator comprising: a sealed film packaging container having an interior side and an exterior side; a pad affixed to the film packaging container on the interior side; and a mount affixed to the film packaging on the exterior side.

4. The applicator of claim 1 wherein a force exerted on the exterior of the receptacle causes the projection to rupture the barrier thereby permitting fluid to seep into the pad.

5. The applicator of claim 1 wherein the receptacle is formed by thermoforming.

6. The applicator of claim 1 wherein the projection is formed by thermoforming.

7. The applicator of claim 1 wherein the projection and receptacle are formed from the same sheet of material.

8. The applicator of claim 1 wherein the receptacle has a semi-rigid structure.

9. The applicator of claim 1 wherein the projection is affixed to the barrier.

10. The applicator of claim 2 wherein the method further comprises a step of grasping the walls of the receptacle by hand and applying the fluid to a surface by a method selected from a group consisting of: wiping, dabbing, smearing, scrubbing, and scouring.

11. The applicator of claim 3 wherein a handle is integrated into the mount.

12. The applicator of claim 3 wherein a handle is attachable to the mount.

13. The applicator of claim 3 wherein the packaging contains a fluid.

14. The applicator of claim 3 wherein at least portions of the mount, the packaging, and the pad form parts of a laminated structure.

15. The applicator of claim 14 wherein the packaging is tearable by hand adjacent the periphery of the laminated structure.
